(19) United States
(12) Patent Application Publication
(10) Pub. No.: US 2013/0166123 A1
(43) Pub. Date: Jun. 27, 2013

(54) VEHICLE SYSTEM FOR ESTIMATING TRAVEL RANGE

(71) Applicant: FORD GLOBAL TECHNOLOGIES, LLC, Dearborn, MI (US)

(72) Inventors: Henry F. Donald, III, Clarkston, MI (US); Ryan Skaff, Farmington Hills, MI (US); Christopher Adam Ochocinski, Canton, MI (US); Sergey Gennadievich Semenov, Farmington Hills, MI (US); Paul Stephen Bryan, Belleville, MI (US)

(73) Assignee: FORD GLOBAL TECHNOLOGIES, LLC, Dearborn, MI (US)

(21) Appl. No.: 13/713,076

(22) Filed: Dec. 13, 2012

Related U.S. Application Data
(60) Provisional application No. 61/578,839, filed on Dec. 21, 2011.

(51) Int. Cl. B60L 11/18

(52) U.S. Cl. CPC B60L 11/1862
USPC 701/22

(57) ABSTRACT

A vehicle system is provided with a controller and an interface communicating with the controller. The controller is configured to receive input that is indicative of available electric energy of a storage device, actual electrical power usage of a climate control system, and thermal requests. The controller is also configured to generate output that is indicative of an estimated travel range in response to the input. The interface is configured to display a range indicator based on the estimated travel range.

### CROSS-REFERENCE TO RELATED APPLICATIONS

This application claims the benefit of U.S. provisional Application No. 61/578,839 filed Dec. 21, 2011, the disclosure of which is incorporated in its entirety by reference herein.

### TECHNICAL FIELD

One or more embodiments relate to a vehicle system for estimating a travel range of a vehicle.

### BACKGROUND

Hybrid electric vehicles (HEVs) utilize a combination of an internal combustion engine with an electric motor to provide the power needed to propel a vehicle. This arrangement provides improved fuel economy over conventional vehicles that only have an internal combustion engine. One method of improving the fuel economy in an HEV is to shutdown the engine during times that the engine operates inefficiently, and is not otherwise needed to propel the vehicle. In these situations, the electric motor is used to provide all of the power needed to propel the vehicle. Battery electric vehicles (BEVs) utilize one or more motors to provide the power needed to propel a vehicle, without an internal combustion engine. By eliminating the engine, BEVs may provide fuel economy improvements over HEVs and further improvements over conventional vehicles.

Vehicles include a number of interfaces, such as gauges, indicators, and displays to convey information to the user regarding the vehicle and its surroundings. For example, conventional vehicles include a fuel gage to indicate the amount of fuel remaining in a fuel tank. A driver may use the fuel gage to estimate how far they can travel using the remaining fuel. Some modern conventional vehicles include systems that correlate the amount of remaining fuel to a distance until the tank is empty, and include an interface for communicating this distance to the driver. Such distance calculations are helpful, however they do not have to be very accurate, because fuel stations are abundant and fuel is easy to transport.

However, “refueling” (charging) a BEV or a plug-in hybrid vehicle (PHEV) is not a simple task because charging infrastructure is less common. Additionally, it typically it takes a number of hours to charge a BEV battery. Therefore an accurate distance to empty (DTE) estimation is a desired feature for BEV and PHEV drivers to determine if their destination is within their range without recharging the vehicle batteries. With the advent of new technologies, the vehicle user interfaces have become more sophisticated. Such user interfaces on BEVs and PHEVs may be configured to convey distance to empty (DTE) information to the user.

### SUMMARY

In one embodiment, a vehicle system is provided with a controller and an interface communicating with the controller. The controller is configured to receive input that is indicative of available electric energy of a battery, actual electrical power usage of a climate control system, and thermal requests. The controller is also configured to generate output that is indicative of an estimated travel range in response to the input. The interface is configured to display a range indicator based on the estimated travel range.

In another embodiment, a vehicle is provided with a motor for propelling the vehicle, a climate control system and a battery that is connected to the motor and the climate control system. The vehicle also includes a controller that is configured to receive input that is indicative of available electric energy of the battery, actual power provided to the motor and the climate control system, and thermal requests. The controller is also configured to provide output that is indicative of an estimated travel range in response to the input.

In yet another embodiment, a method for estimating vehicle travel range is provided. At least one auxiliary power value is generated based on actual electrical power usage of a climate control system and thermal requests that are indicative of future electrical power usage. An estimated travel range is generated for a vehicle based on actual driving power, available electric energy and the at least one auxiliary power value.

### BRIEF DESCRIPTION OF THE DRAWINGS

FIG. 1 is a schematic diagram of a vehicle having a vehicle system for estimating travel range according to one or more embodiments;

FIG. 2 is an enlarged schematic view of a portion of the vehicle of FIG. 1;

FIG. 3 is a schematic block diagram illustrating a control system and method for estimating travel range of the vehicle of FIG. 1, according to one or more embodiments;

FIG. 4 is flow chart illustrating the method for estimating travel range of FIG. 3;

FIG. 5 is an enlarged portion of the method of FIG. 4;

FIG. 6 is another enlarged portion of the method of FIG. 4;

FIG. 7 is a front perspective view of a user interface of the vehicle system of FIG. 1; and

FIG. 8 is an enlarged view of the user interface of FIG. 7 according to one or more embodiments.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

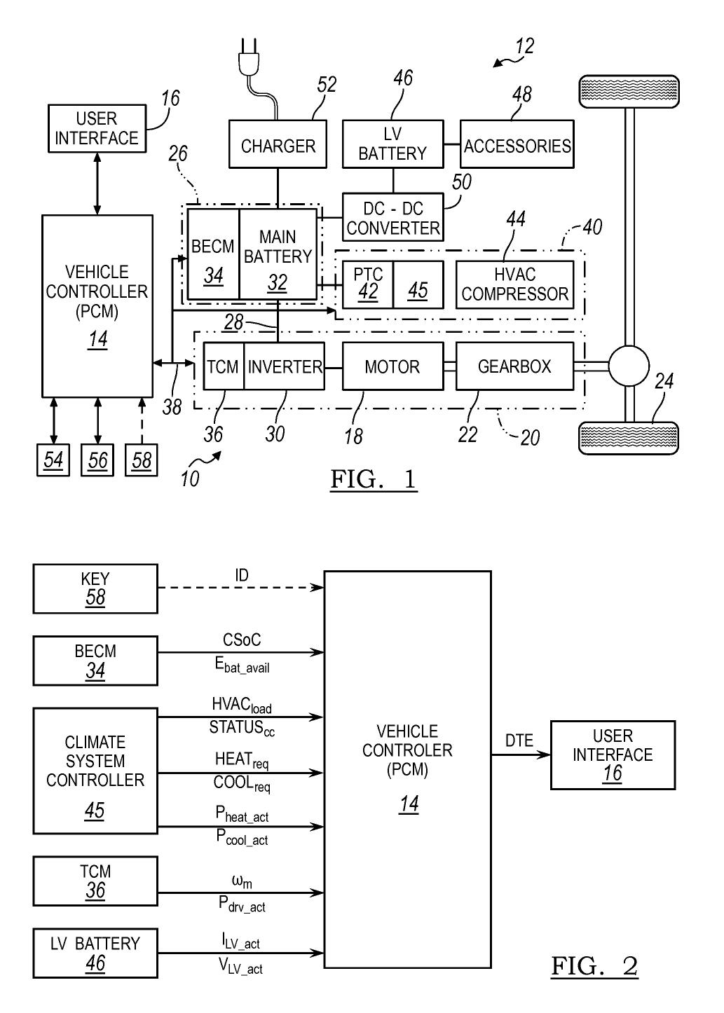

With reference to FIG. 1, a vehicle system for estimating a travel range is illustrated in accordance with one or more embodiments and is generally referenced by numeral 10. The vehicle system 10 is depicted within a vehicle 12. The vehicle system 10 includes a controller 14 and a user interface 16 that are in communication with each other. The controller 14 receives input signals and determines an estimated travel range of the vehicle 12. The controller 14 transmits this information to the user interface 16, which in turn conveys the information to the driver in real time. The driver uses this information as a guide, and may adjust their driving behavior and usage of vehicle accessories in order to adjust the estimated travel range.

The illustrated embodiment depicts the vehicle 12 as a battery electric vehicle (BEV), which is an all-electric vehicle propelled by an electric motor 18 without assistance from an internal combustion engine (not shown). The motor 18 receives electrical power and provides output mechanical power. The motor 18 also functions as a generator for converting mechanical power into electrical power. The vehicle 12 has a transmission 20 that includes the motor 18 and a gearbox 22. The gearbox 22 adjusts the output torque and speed of the motor 18 by a predetermined gear ratio. An output shaft extends from the gearbox 22 and connects to a differential. A pair of half-shafts extend in opposing directions from the differential to a pair of drive wheels 24.

Although illustrated and described in the context of the vehicle 12, which is a BEV, it is understood that embodiments of the present application may be implemented on other types of vehicles, such as those powered by an internal combustion engine in addition to one or more electric machines (e.g., hybrid electric vehicles (HEVs), full hybrid electric vehicles (FHEVs) and plug-in electric vehicles (PHEVs), etc.).

The vehicle 12 includes an energy storage system 26 for storing and controlling electrical energy. A high voltage bus 28 electrically connects the motor 18 to the energy storage system 26 through an inverter 30. The energy storage system 26 includes a main battery 32 and a battery energy control module (BECM) 34 according to one or more embodiments. The main battery 32 is a high voltage battery that is capable of outputting electrical power to operate the motor 18. The main battery 32 also receives electrical power from the motor 18, when the motor 18 is operating as a generator. The inverter 30 converts the direct current (DC) power supplied by the main battery 32 to alternating current (AC) power for operating the motor 18. The inverter 30 also converts alternating current (AC) provided by the motor 18, when acting as a generator, to DC for charging the main battery 32. The main battery 32 is a battery pack made up of several battery modules (not shown), where each battery module contains a plurality of battery cells (not shown). The BECM 34 acts as a controller for the main battery 32. The BECM 34 also includes an electronic monitoring system that manages temperature and state of charge of each of the battery cells. Other embodiments of the vehicle 12 contemplate different types of energy storage systems, such as capacitors and fuel cells (not shown).

The transmission 20 includes a traction control module (TCM) 36 for controlling the motor 18 and the inverter 30. The TCM 36 monitors, among other things, the position, speed, and power consumption of the motor 18 and provides output signals corresponding to this information to other vehicle systems (e.g., the vehicle controller 14). The TCM 36 and the inverter 30 convert the direct current (DC) voltage supply by the main battery 32 into alternating current (AC) signals that are used to control the motor 18.

The vehicle controller 14 communicates with other vehicle systems and controllers for coordinating their function. Although it is shown as a single controller, the vehicle controller 14 may include multiple controllers that may be used to control multiple vehicle systems according to an overall vehicle system control (VSC) logic, or software. For example, the vehicle controller 14 may be a powertrain control module (PCM) having a portion of the VSC software embedded within a module. The vehicle controller 14 generally includes any number of microprocessors, ASICs, ICs, memory (e.g., FLASH, ROM, RAM, EPROM and/or EEPROM) and software code to co-act with one another to perform a series of operations. The vehicle controller 14 includes predetermined data, or “look up tables” that are stored within the memory, and based on calculations and test data. The vehicle controller 14 communicates with other controllers (e.g., TCM 36, BECM 34) over a hardline vehicle connection 38 using a common bus protocol (e.g., CAN).

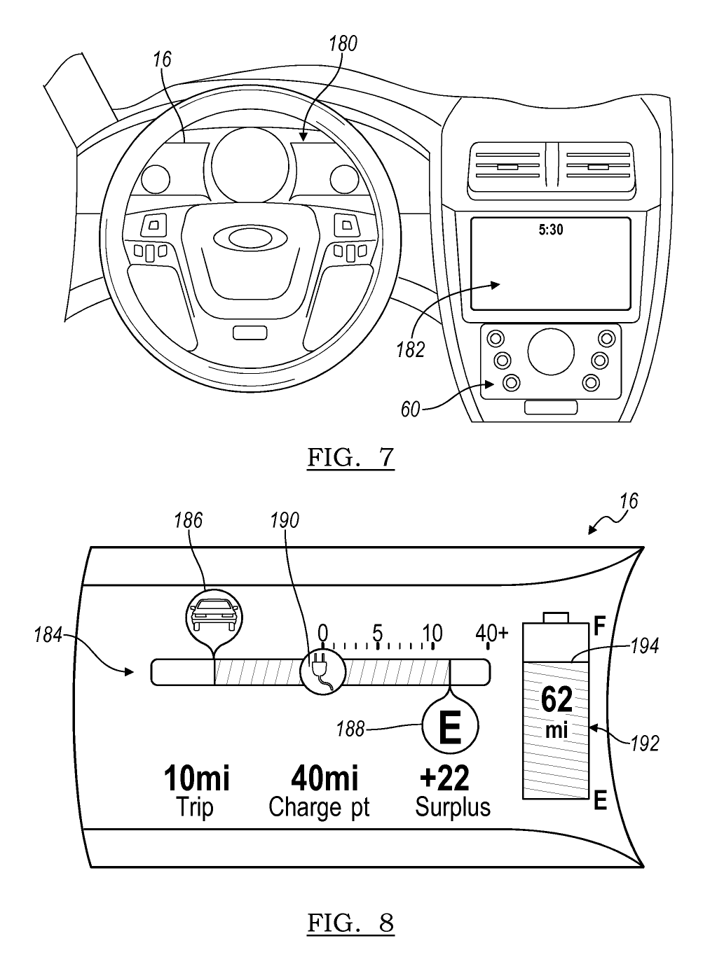

The user interface 16 communicates with the vehicle controller 14 for receiving information regarding the vehicle 12 and its surroundings, and conveys this information to the driver. The user interface 16 includes a number of interfaces, such as gauges, indicators, and displays (shown in FIG. 7). The user interface 16 also includes external devices, such as a computer or cellular phone in one or more embodiments. The vehicle controller 14 provides output to the user interface 16, such as a status of the motor 18 or battery 32, which is conveyed visually to the driver.

The vehicle 12 includes a climate control system 40 for heating and cooling various vehicle components and a passenger compartment (not shown). The climate control system 40 includes a high voltage positive temperature coefficient (PTC) electric heater 42 and a high voltage electric HVAC compressor 44, according to one or more embodiments. The PTC heater 42 and HVAC compressor 44 are used to heat and cool fluid, respectively, that circulates to the transmission 20 and to the main battery 32. Both the PTC heater 42 and the HVAC compressor 44 may draw electrical energy directly from the main battery 32. The climate control system 40 includes a climate controller 45 for communicating with the vehicle controller 14 over the CAN bus 38. The on/off status of the climate control system 40 is communicated to the vehicle controller 14, and can be based on, for example, the status of an operator actuated switch, or the automatic control of the climate control system 40 based on related functions, such as window defrost. In other embodiments, the climate control system 40 is configured for heating and cooling air (e.g., existing vehicle cabin air) rather than fluid, and circulating the air through the battery 32 and/or transmission 20.

The vehicle 12 includes a secondary low voltage (LV) battery 46, such as a 12-volt battery, according to one embodiment. The secondary battery 46 may be used to power various vehicle accessories such as headlights and the like, which are collectively referred to herein as accessories 48. A DC-to-DC converter 50 is electrically connected between the main battery 32 and the LV battery 46. The DC-to-DC converter 50 adjusts, or “steps down” the voltage level to allow the main battery 32 to charge the LV battery 46. A low voltage bus electrically connects the DC-to-DC converter 50 to the LV battery 46 and the accessories 48.

The vehicle 12 includes an AC charger 52 for charging the main battery 32. An electrical connector connects the AC charger 52 to an external power supply (not shown) for receiving AC power. The AC charger 52 includes power electronics used to invert, or “rectify” the AC power received from the external power supply to DC power for charging the main battery 32. The AC charger 52 is configured to accommodate one or more conventional voltage sources from the external power supply (e.g., 110 volt, 220 volt, etc.). The external power supply may include a device that harnesses renewable energy, such as a photovoltaic (PV) solar panel, or a wind turbine (not shown).

Also shown in FIG. 1 are simplified schematic representations of a driver controls system 54 and a navigation system 56. The driver controls system 54 includes braking, acceleration and gear selection (shifting) systems (all not shown). The braking system includes a brake pedal, position sensors, pressure sensors, or some combination thereof, as well as a mechanical connection to the vehicle wheels, such as the primary drive wheels 24, to effect friction braking. The braking system may also be configured for regenerative braking, wherein braking energy may be captured and stored as electrical energy in the main battery 32. The acceleration system includes an accelerator pedal having one or more sensors, which, like the sensors in the braking system, provide information such as a driver request for torque to the vehicle controller 14. The gear selection system includes a shifter for manually selecting a gear setting of the gearbox 22. The gear selection system may include a shift position sensor for providing shifter selection information (e.g., PRNDL) to the vehicle controller 14. The navigation system 56 may include a navigation display, a global positioning system (GPS) unit, a navigation controller and inputs (all not shown) for receiving destination information or other data from a driver. These components may be unique to the navigation system 56 or shared with other systems. The navigation system 56 may also communicate distance and/or location information associated with the vehicle 12, its target destinations, or other relevant GPS waypoints.

The system 10 includes a key 58 for unlocking the vehicle and starting an ignition system (not shown). The key 58 includes a transmitter (not shown) for transmitting a signal that represents an identity of a user of the specific key 58, according to one or more embodiments.

With reference to FIGS. 1 and 2, the vehicle controller 14 receives input that is indicative of current operating conditions of vehicle systems, and provides output to coordinate their function. Each input may be a signal transmitted directly between the vehicle controller 14 and the corresponding vehicle system, or indirectly as input data over the CAN bus 38.

The vehicle controller 14 is configured to save the input data as historic data for future reference. The vehicle controller may save a certain quantity of data that corresponds to a time period (e.g., five hours of data), and continuously update the historic data with new historic data. The vehicle controller 14 accesses the historic data for calculating average values. The vehicle controller 14 may be configured to ignore, or not save input data under certain vehicle conditions. For example, in one embodiment, the vehicle controller 14 is configured to not save input data when the vehicle 12 is on, but not moving or “torque enabled”. For example, the vehicle controller 14 may be configured to not save input data when the vehicle is unoccupied, e.g., during charging or when a user has remotely started the vehicle.

The vehicle controller 14 receives input (ID) that represents an identity of a user of the key 58. The ID signal may be transmitted wirelessly, e.g., as a radio frequency (RF) signal. A user may possess multiple keys 58 for their vehicle, where each key transmits a distinct ID signal. Distinct ID signals may be used to configure different vehicle use. For example, a primary user may limit certain vehicle accessories that are accessible to a secondary user.

The BECM 34 provides input (E_{bat}_{_{—}}ₐᵥₐᵢₗ, CSoC) to the vehicle controller 14 that represents the status of the main battery 32. The BECM 34 monitors battery conditions such as battery voltage, current, temperature and state of charge measured values. The BECM also compares current battery conditions to historic data to evaluate battery life (“aging”), change in capacity over time, faults, and any predetermined limits. The E_{bat}_{_{—}}ₐᵥₐᵢₗ input represents the available electric energy of the main battery 32 based on measured and predetermined battery values. The CSoC input represents the battery state of charge as a percentage (from 100% to 0%).

The vehicle controller 14 receives input (Pₕₑₐₜ_{_{—}}_{heatact}, P_{cool}_{_{—}}_{act}) that represents the actual electrical power usage by the climate control system 40 to heat and cool the vehicle 12. The Pₕₑₐₜ_{_{—}}_{act} input represents the actual electrical power provided to the ptc heater 42 to heat the vehicle. The P_{cool}_{_{—}}_{act} input represents the actual electrical power provided to the HVAC compressor 44 to cool the vehicle 12. In other embodiments, the vehicle controller 14 may receive voltage and current measurements that correspond to electrical power.

The climate controller 45 provides input (HVAC_{load}, STATUS_{cc}, HEAT_{req}, COOL_{req}) to the vehicle controller 14 that represent vehicle temperature conditions and driver thermal requests. The HVAC_{load} input represents the electrical load of the climate control system 40 based on temperature conditions inside the vehicle 12. The HEAT_{req} input represents a driver request for heating, and the COOL_{req} input represents a driver request for cooling. The STATUS_{cc} input represents an on/off status of the climate control system 40. The STATUS_{cc}, HEAT_{req} and COOL_{req} inputs are each based on a position of an operator actuated switch, knob or dial, which are collectively referred to as thermal controls 60 and illustrated in FIG. 7.

The climate control system 40 also includes a defrost feature where both the PTC heater 42 and HVAC compressor 44 are used to collectively melt ice and remove humidity from a front or rear window (not shown) of the vehicle 12. In one or more embodiments, the climate controller 45 also provides an input (not shown) to the vehicle controller 14 that represents a driver request for defrost.

The vehicle controller 14 receives input (ωₘ, P_{dry}_{_{—}}_{act}) that is indicative of motor 18 conditions. The ωₘ input represents the output speed of the motor 18, and the P_{drv}_{_{—}}_{act} input represents the actual electrical power provided to the motor 18 for driving or propelling the vehicle 12.

The vehicle controller receives input (I_{LV}_{_{—}}_{act}, V_{LV}_{_{—}}_{act}) that represents the actual power usage of the LV battery 46. The vehicle 12 includes sensors (not shown) that measure the actual voltage and current that is provided by the main battery 32 to the LV battery 46. These sensors provide the I_{LV}_{_{—}}_{act} and V_{LV}_{_{—}}_{act} inputs, which represent the actual current and the actual voltage provided to the LV battery 46, respectively. In other embodiments, the vehicle controller 14 receives an input signal corresponding to the actual power (not shown) that is provided to the LV battery 46.

The vehicle controller 14 evaluates the input and provides output to the user interface 16 that represents an estimated vehicle travel range, or “distance to empty” (DTE).

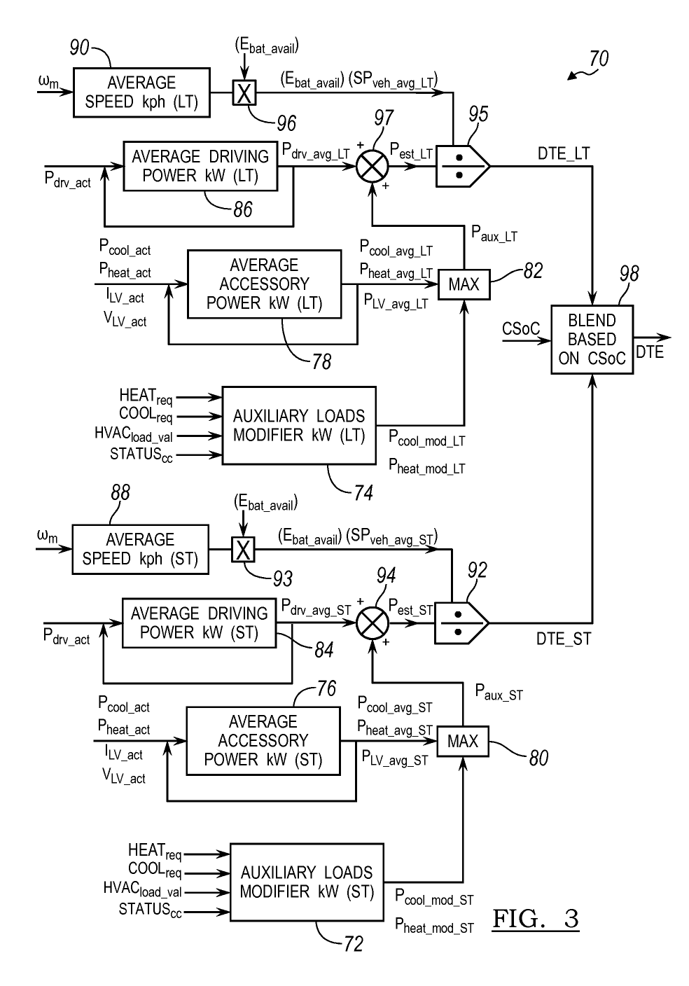

With reference to FIG. 3, a schematic block diagram illustrating operation of a control system or method for estimating travel range is illustrated in accordance with one or more embodiments and is generally referenced by numeral 70. The control system 70 evaluates the input in the time domain at both a predetermined short time (ST) period (e.g., between five and twenty minutes) and a predetermined long time (LT) period (e.g., between one and three hours). The control system 70 is contained within the vehicle controller 14 according to one or more embodiments, and may be implemented in hardware and/or software control logic as described in greater detail herein.

The control system 70 determines short term auxiliary load modifiers (P_{cool}_{_{—}}_{mod}_{_{—}}_{ST},Pₕₑₐₜ_{_{—}}_{mod}_{_{—}}_{ST}) at block 72. The short term auxiliary load modifiers include a short term cooling modification value (P_{cool}_{_{—}}_{mod}_{_{—}}_{ST}), that represents an estimate of future electrical power usage for cooling the vehicle 12. The short term auxiliary load modifiers also include a short term heating modification value (Pₕₑₐₜ_{_{—}}_{mod}_{_{—}}_{ST}), that represents an estimate of future electrical power usage for heating the vehicle 12. The control system 70 receives the HVAC_{load} input, which represents a numerical value that corresponds to a predetermined temperature range. For example, in one embodiment, the HVAC_{load} input corresponds to a numerical value between 0 and 254, where 0 corresponds to a cold condition where high electrical power is provided to the PTC heater 42, and 254 corresponds to a hot condition where high electrical power is provided to the HVAC compressor 44. The range is generally linear, and therefore HVAC_{load} values at the middle of the range (e.g., between 126 and 128) correspond to nominal or medium temperature conditions, where minimal electrical power is provided to the PTC heater 42 and the HVAC compressor 44. The control system 70 compares the HVAC_{load} input to predetermined ST data to determine the short term modification values (P_{cool}_{_{—}}_{mod}_{_{—}}_{ST}, Pₕₑₐₜ_{_{—}}_{mod}_{_{—}}_{ST}).

Although the temperature may be hot or cold, the driver might not request a change in temperature conditions. For example, on a hot day, a driver may open the windows rather than turn on the air conditioning to cool their vehicle. The control system 70 also evaluates the STATUS_{cc}, HEAT_{req}, and COOL_{req}inputs at block 72 to determine if either of the short term auxiliary load modifiers (P_{cool}_{_{—}}_{mod}_{_{—}}_{ST}, Pₕₑₐₜ_{_{—}}_{mod}_{_{—}}_{ST}) are adjusted. For example, if the driver has not turned the climate control system on, then the STATUS_{cc} represents “off”, and the power modification values are set equal to zero.

Also, each thermal request (HEAT_{req}, COOL_{req})represents a numerical value between zero and three, according to one or more embodiments. A thermal request that represents a value of zero corresponds to an “off” condition, where the user is requesting that the corresponding heating or cooling device is turned off. The control system 70 sets the corresponding auxiliary load modifier to zero in response to an off request. A thermal request that represents a value of one corresponds to a “low” condition, where the user is requesting that the corresponding heating or cooling system operates at less than maximum capability to heat or cool the vehicle. The control system 70 may decrease a power modification value at block 72 in response to a low condition. A thermal request that represents a value of two corresponds to a “high” condition, where the user is requesting that the corresponding heating or cooling system operates at maximum capability to heat or cool the vehicle. A heating request (HEAT_{req}) that represents a value of three corresponds to a “defrost” condition.

Also when both thermal requests (HEAT_{req}, COOL_{req}) represent a value of three, then this condition corresponds to a user request for maximum defrost.

Long term auxiliary load modifiers (P_{cool}_{_{—}}_{mod}_{_{—}}_{LT},Pₕₑₐₜ_{_{—}}_{mod}_{_{—}}_{LT}) are determined at block 74. The long term auxiliary modifiers include a long term cooling modification value (P_{cool}_{_{—}}_{mod}_{_{—}}_{LT}), and a long term heating modification value (Pₕₑₐₜ_{_{—}}_{mod}_{_{—}}_{LT}) that represent estimates of future electrical power usage for cooling and heating the vehicle 12, respectively. The control system 70 receives the HVAC_{load} input at block 74, and compares it to predetermined LT data to determine the long term auxiliary load modifiers (P_{cool}_{_{—}}_{mod}_{_{—}}_{LT}, Pₕₑₐₜ_{_{—}}_{mod}_{_{—}}_{LT}). The control system 70 also evaluates the STATUS_{cc}, HEAT_{req} and COOL_{req} inputs at block 74 to determine if either of the auxiliary load modifiers (P_{cool}_{_{—}}_{mod}_{_{—}}_{LT}, Pₕₑₐₜ_{_{—}}_{mod}_{_{—}}_{LT}) are adjusted.

The power required to heat or cool the interior of the vehicle decreases over time as the interior temperature approaches a desired nominal temperature. Therefore the predetermined ST data differs from the predetermined LT data, and the short term auxiliary load modifiers are generally larger than the long term load modifiers. For example, in one embodiment, the control system 70 receives an HVAC_{load} input that represents a value of 254 and corresponds to a cold condition, (e.g., a temperature of −20 degrees Celsius). The control system 70 determines that P_{cool}_{_{—}}_{mod}_{_{—}}_{ST} equals zero and Pₕₑₐₜ_{_{—}}_{mod}_{_{—}}_{ST} equals 5.0 kilowatts at block 72; and that P_{cool}_{_{—}}_{mod}_{_{—}}_{LT} equals zero and Pₕₑₐₜ_{_{—}}_{mod}_{_{—}}_{LT} equals 1.7 kilowatts at block 74. The short term heating modification value (Pₕₑₐₜ_{_{—}}_{mod}_{_{—}}_{ST}) is larger than the long term heating modification value (Pₕₑₐₜ_{_{—}}_{mod}_{_{—}}_{LT}) because the electrical power provided to heat the interior of the vehicle will decrease over time as the interior of the vehicle retains heat.

The control system 70 determines short term average accessory power values (P_{cool}_{_{—}}_{avg}_{_{—}}_{ST}, Pₕₑₐₜ_{_{—}}_{avg}_{_{—}}_{ST}, P_{LV}_{_{—}}_{avg}_{_{—}}_{ST}) at block 76. The control system 70 receives the P_{cool}_{_{—}}_{act}, Pₕₑₐₜ_{_{—}}_{act}, I_{LV}_{_{—}}_{act}, and V_{LV}_{_{—}}_{act} inputs at block 76, which represent the actual electrical power provided to cool and heat the vehicle, as well as the actual current and voltage provided to operate the low voltage accessories. The short term average accessory power values include a short term average cooling power (P_{cool}_{_{—}}_{avg}_{_{—}}_{ST}) which represents an average of the electrical power provided to cool the vehicle during a short time period. The short term average cooling power (P_{cool}_{_{—}}_{avg}_{_{—}}_{ST}) is calculated by averaging the P_{cool}_{_{—}}_{act}_{_{—}}_{ST} input and historic P_{cool}_{_{—}}_{act}_{_{—}}_{ST} data that was received over the predetermined short period of time (ST). This calculation is referred to herein as taking a “rolling average”. Similarly, the control system 70 calculates a short term average heating power (Pₕₑₐₜ_{_{—}}_{avg}_{_{—}}_{ST}) at block 76, by taking a rolling average of the Pₕₑₐₜ_{_{—}}_{act}_{_{—}}_{ST} input and historic Pₕₑₐₜ_{_{—}}_{act}_{_{—}}_{ST} data that was received during the ST. For example, in one embodiment ST is equal to five minutes, and the control system 70 calculates Pₕₑₐₜ_{_{—}}_{avg}_{_{—}}_{ST} by taking a rolling average of the Pₕₑₐₜ_{_{—}}_{act}_{_{—}}_{ST} input and historic data that was received during the last five minutes of recorded data.

The short term average accessory power values also include a short term low voltage power (P_{LV}_{_{—}}_{avg}_{_{—}}_{ST}) which represents an average of the electrical power provided to operate the low voltage accessories during a short time period. The control system 70 calculates a short term average low voltage power (P_{LV}_{_{—}}_{avg}_{_{—}}_{ST}) at block 76, by first calculating an actual low voltage power as a product of the I_{LV}_{_{—}}_{act}, and V_{LV}_{_{—}}_{act} inputs, and then taking a rolling average of this actual low voltage power value over the predetermined time period (ST).

Long term average accessory power values (P_{cool}_{_{—}}_{avg}_{_{—}}_{LT}, Pₕₑₐₜ_{_{—}}_{avg}_{_{—}}_{LT}, P_{LV}_{_{—}}_{avg}_{_{—}}_{LT}) are determined at block 78, which represent long term averages of the actual power provided to heat, cool, and operate accessories within the vehicle. The control system 70 receives the Pₕₑₐₜ_{_{—}}_{act}, P_{cool}_{_{—}}_{act}, I_{LV}_{_{—}}_{act}) and V_{LV}_{_{—}}_{act} inputs at block 78, which represent the actual electrical power provided to heat and cool the vehicle, as well as the actual current and voltage provided to operate the low voltage accessories. A long term average cooling power value (P_{cool}_{_{—}}_{avg}_{_{—}}_{LT}) is calculated at block 78 by taking a rolling average of the P_{cool}_{_{—}}_{act}_{_{—}}_{LT} input and the historic P_{cool}_{_{—}}_{act}_{_{—}}_{LT} data over the predetermined short period of time (LT). Similarly, the control system 70 calculates a long term average heating power value (Pₕₑₐₜ_{_{—}}_{avg}_{_{—}}_{LT}) by taking a rolling average of the Pₕₑₐₜ_{_{—}}_{act}_{_{—}}_{LT} input and the historic Pₕₑₐₜ_{_{—}}_{act}_{_{—}}_{LT} data over the long period of time (LT). The control system 70 calculates a long term average low voltage power value (P_{LV}_{_{—}}_{avg}_{_{—}}_{LT}) at block 78, by first calculating an actual low voltage power as a product of the I_{LV}_{_{—}}_{act} and V_{LV}_{_{—}}_{act} inputs and then taking a rolling average of this actual low voltage power value and a historic low voltage power data over the predetermined long time period (LT).

The control system 70 determines a short term auxiliary power value (-Pₐᵤₓ_{_{—}}_{ST}) at block 80. The control system 70 compares each short term average heating and cooling accessory power value from block 76, to a corresponding short term heating and cooling auxiliary load modification value from block 72, to determine which value is larger. The control system 70 then calculates the short term auxiliary power value (Pₐᵤₓ_{_{—}}_{ST}) based on a sum of each larger value and the short term low voltage accessory power value (P_{LV}_{_{—}}_{avg}_{_{—}}_{ST}).

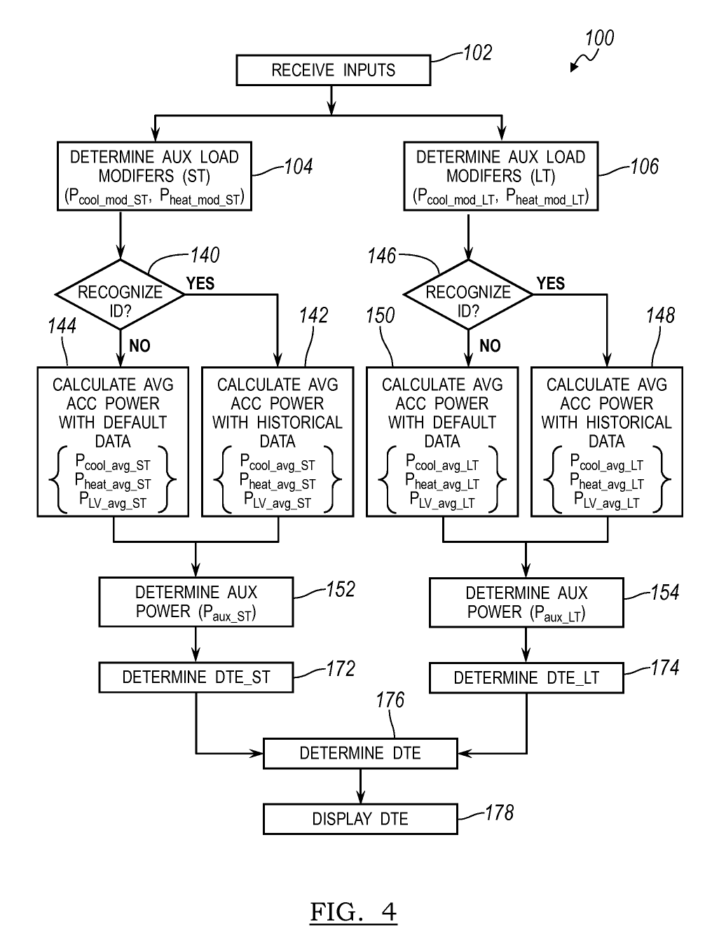

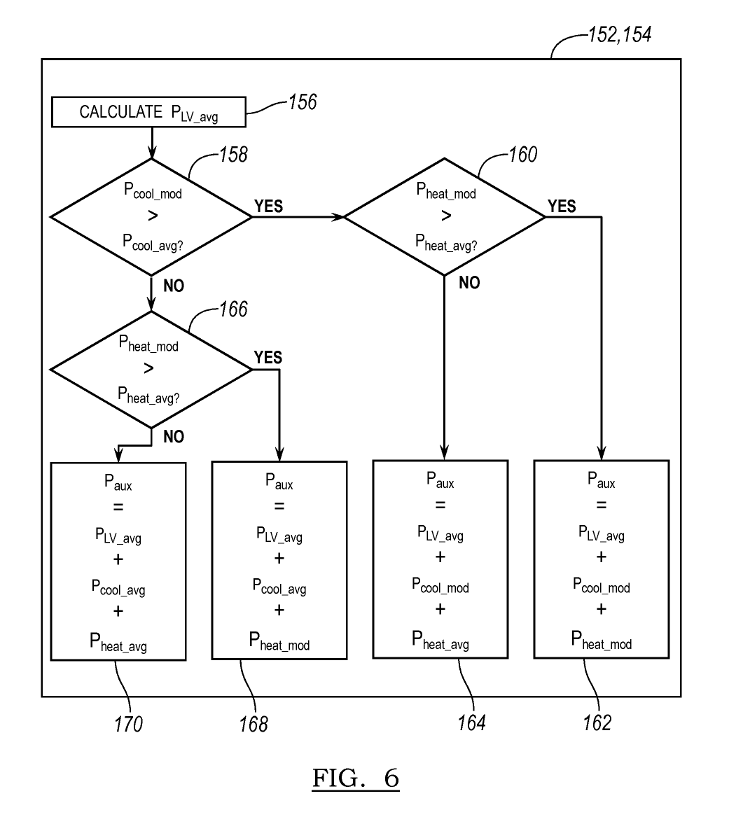

A long term auxiliary power value (Pₐᵤₓ_{_{—}}_{LT}) is determined at block 82. The control system 70 compares each long term average heating and cooling accessory power value from block 78, to a corresponding long term heating and cooling auxiliary load modification value from block 74, to determine which value is larger value. The control system 70 then calculates the long term auxiliary power value (Pₐᵤₓ_{_{—}}_{LT}) based on a sum of each larger value and the long term low voltage accessory power value (P_{LV}_{_{—}}_{avg}_{_{—}}_{LT}). The determination of Pₐᵤₓ_{_{—}}_{LT} is described in further detail below with respect to FIGS. 4 and 6.

The control system 70 calculates a short term average driving power (P_{dry}_{_{—}}_{avg}_{_{—}}_{ST}) at block 84. The control system 70 receives the actual driving power (P_{dry}_{_{—}}_{act}) input which represents the actual electrical power usage for vehicle propulsion. The short term average driving power (P_{drv}_{_{—}}_{avg}_{_{—}}_{ST}) is calculated at block 84 by taking a rolling average of the P_{drv}_{_{—}}_{act} input and the historic P_{drv}_{_{—}}_{act} data over the predetermined short period of time (ST).

A long term average driving power (P_{drv}_{_{—}}_{avg}_{_{—}}_{LT}) is calculated at block 86. The long term average driving power value (P_{drv}_{_{—}}_{-avg}_{_{—}}_{LT}) is calculated at block 86 by taking a rolling average of the P_{drv}_{_{—}}_{act} input and the historic P_{drv}_{_{—}}_{act} data over the predetermined long period of time (LT).

The control system 70 calculates a short term average speed (SPᵥₑₕ_{_{—}}_{avg}_{_{—}}_{ST}) at block 88. The control system 70 receives the motor speed input (ωₘ) and calculates vehicle speed by multiplying ωₘ by a predetermined gear ratio corresponding to the mechanical connections between the motor and the drive wheels (shown in FIG. 1). The short term average vehicle speed (SPᵥₑₕ_{_{—}}_{avg}_{_{—}}_{ST}) is calculated at block 88 by taking a rolling average of the calculated vehicle speed over the predetermined short period of time (ST).

A long term average speed (SPᵥₑₕ_{_{—}}_{avg}_{_{—}}_{LT}) is determined at block 90. The control system 70 receives the motor speed input (ωₘ) and calculates vehicle speed by multiplying ωₘ by the predetermined gear ratio. The long term average vehicle speed (SPᵥₑₕ_{_{—}}_{avg}_{_{—}}_{LT}) is calculated at block 90 by taking a rolling average of the calculated vehicle speed over the predetermined long period of time (LT).

The control system 70 calculates a short term estimated travel range (DTE_{ST}) at division junction 92. The control system 70 receives the available electric energy (E_{bat}_{_{—}}ₐᵥₐᵢₗ) input. The available electric energy (E_{bat}_{_{—}}ₐᵥₐᵢₗ) and the short term average vehicle speed (SPᵥₑₕ_{_{—}}_{avg}_{_{—}}_{ST}) are multiplied together at multiplication junction 93. The short term average driving power (P_{drv}_{_{—}}_{avg}_{_{—}}_{ST}) and the short term auxiliary power (Pₐᵤₓ_{_{—}}_{ST}) are added together at summing junction 94. The short term estimated travel range (DTE_{ST}) is calculated at division junction 92 by dividing the product (E_{bat}_{_{—}}ₐᵥₐᵢₗ*SPᵥₑₕ_{_{—}}_{avg}_{_{—}}_{ST}) provided by multiplication junction 93, by the sum (P_{drv}_{_{—}}_{avg}_{_{—}}_{ST}+Pₐᵤₓ_{_{—}}_{ST}) provided by summing junction 94. Thus, the short term estimated travel range (DTE_{ST}) is calculated according to equation 1 as shown below:

$$D T {E}_{ST} = \frac{{E}_{bat \_ avail} * {SP}_{veh \_ avg \_ ST}}{{P}_{drv \_ avg \_ ST} + {P}_{aux \_ ST}} \qquad Eq . 1$$

A long term estimated travel range (DTE_{LT}) is determined at division junction 95. The available electric energy (E_{bat}_{_{—}}ₐᵥₐᵢₗ) an the long term average vehicle speed (SPᵥₑₕ_{_{—}}_{avg}_{_{—}}_{LT}) are multiplied together at multiplication junction 96. The long term average driving power (P_{drv}_{_{—}}_{avg}_{_{—}}_{LT}) and the long term auxiliary power (Pₐᵤₓ_{_{—}}_{LT}) are added together at summing junction 97. The long term estimated travel range (DTE_{LT}) is calculated at division junction 95 by dividing the product (E_{bat}_{_{—}}ₐᵥₐᵢₗ*SPᵥₑₕ_{_{—}}_{avg}_{_{—}}_{LT}) provided by multiplication junction 96, by the sum (P_{drv}_{_{—}}_{avg}_{_{—}}_{LT}+Pₐᵤₓ_{_{—}}_{LT}) provided by summing junction 97. Thus, the long term estimated travel range (DTE_{LT}) is calculated according to equation 2 as shown below:

$$D T {E}_{LT} = \frac{{E}_{bat \_ avail} * {SP}_{veh \_ avg \_ LT}}{{P}_{drv \_ avg \_ LT} + {P}_{aux \_ LT}} \qquad Eq . 2$$

The control system 70 determines the estimated travel range (DTE) at block 98 based on the customer state of charge (CSoC) input. The control system 70 receives the CSoC input at block 98. The CSoC is compared to predetermined data to determine a short term weighting factor (ST %) and a long term weighting factor (LT %). The travel range (DTE) is then calculated by blending the short term estimated travel range (DTE_{ST}) and the long term estimated travel range (DTE_{LT}) based on their corresponding weighting factor.

In at least one embodiment, the predetermined data includes a long term weighting factor (LT %) that directly relates to the CSoC value, and a short term weighting factor (ST %) that inversely relates to the CSoC value. For example, in one such embodiment, a CSoC value of 100% corresponds to a predetermined LT % of 100%, and a predetermined ST % of 0%. Therefore at full CSoC, the estimated travel range (DTE) is equal to the long term estimated travel range (DTE_{LT}). In another example, a CSoC value of 10% corresponds to a predetermined LT % of 0%, and a predetermined ST % of 100%. Therefore at low CSoC, the estimated travel range (DTE) is equal to the short term estimated travel range (DTE_{ST}).

Such a blending approach improves the accuracy of the DTE estimate as compared to existing methods of estimating DTE. For example, when the CSoC is low, the DTE estimate is weighted more heavily towards the short term estimated travel range (DTE_{ST}) which results in rapid changes in the DTE. These rapid changes allow the driver to make changes in their driving behavior and quickly see the impact on the estimated travel range (DTE). For example, a driver operating a vehicle with a low CSoC on a hot day with the HVAC compressor on, could see an increase in the DTE within a few minutes, by turning the HVAC compressor off.

Although the above control system 70 is described with respect to a BEV based on the available electric energy, other embodiments of the control system 70 are contemplated for HEVs and PHEVs operating in an electric or “charge depleting mode”. Additionally, HEVs and PHEVs operating in a hybrid mode may include control systems (not shown) may calculate an overall travel range based on a combination of the estimated travel range (DTE) and an estimated travel range based on remaining fuel.

FIGS. 4-6 illustrate a method 100 for implementing the control system 70 for estimating travel range of FIG. 3. The control system 70 is performed by the vehicle controller 14 of FIGS. 1 and 2, according to one or more embodiments. In operation 102, inputs are received from individual systems or sensors of the vehicle including the inputs described with respect to FIGS. 2 and 3.

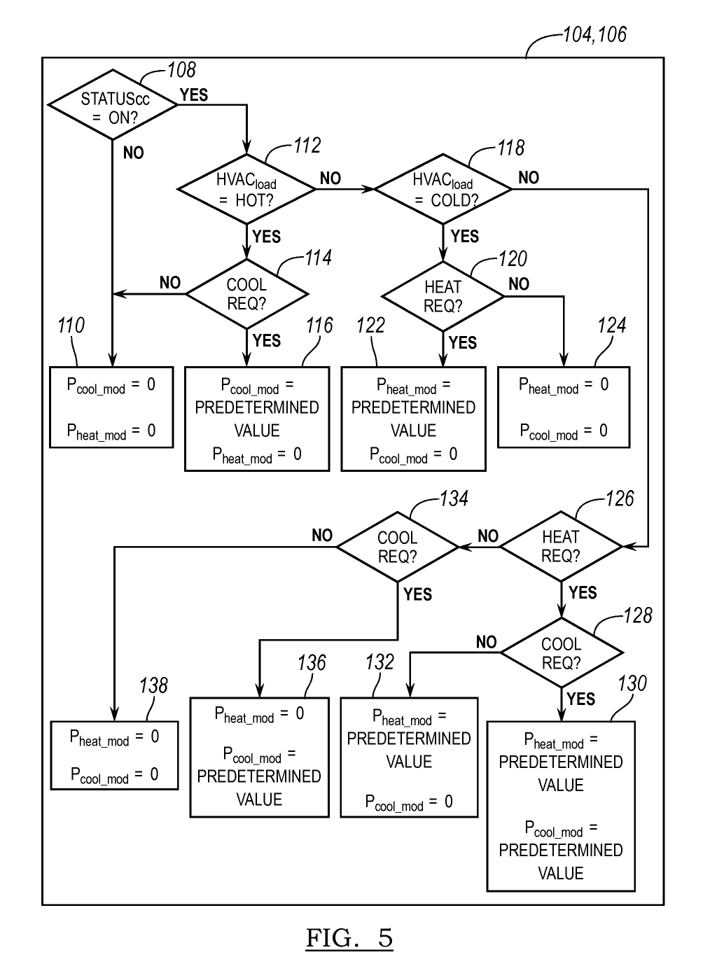

In operation 104, the vehicle controller determines the short term auxiliary load modifiers (P_{cool}_{_{—}}_{mod}_{_{—}}_{ST}, Pₕₑₐₜ_{_{—}}_{mod}_{_{—}}_{ST}). In operation 106, the long term auxiliary load modifiers (P_{cool}_{_{—}}_{mod}_{_{—}}_{LT}, Pₕₑₐₜ_{_{—}}_{mod}_{_{—}}_{LT}) are determined. FIG. 5 provides an enlarged view of the sub operations within the determinations of both the short term auxiliary load modifiers in operation 104, and long term auxiliary load modifiers in operation 106. The only difference between the determinations at operation 104 and 106 is the time period. Therefore the operations depicted in FIG. 5, are illustrated without reference to the time period, and apply to both the short time period (ST) and the long time period (LT).

In operation 108, the climate control status (STATUS_{cc}) input is evaluated to determine if the climate control system is on or off. If the climate control system is off, then the short term auxiliary load modifiers (P_{cool}_{_{—}}_{mod}_{_{—}}_{ST}, Pₕₑₐₜ_{_{—}}_{mod}_{_{—}}_{ST}) and the long term auxiliary load modifiers (P_{cool}_{_{—}}_{mod}_{_{—}}_{LT}, Pₕₑₐₜ_{_{—}}_{mod}_{_{—}}_{LT}) are all set equal to zero at operation 110. If the climate control system is on, the vehicle controller proceeds to operation 112.

The HVAC load value (HVAC_{load}) is compared to predetermined data at operation 112 to determine a vehicle temperature condition. If the HVAC_{load} input indicates a hot temperature condition, then the vehicle controller proceeds to operation 114. The cooling request (COOL_{req}) is evaluated at operation 114. If the user is requesting cooling (e.g., COOL_{req} is greater than zero), then the vehicle controller proceeds to operation 116 and sets each cooling modification value (P_{cool}_{_{—}}_{mod}_{_{—}}_{ST}, P_{cool}_{_{—}}_{mod}_{_{—}}_{LT}) equal to a predetermined value, and the heating modification values (Pₕₑₐₜ_{_{—}}_{mod}_{_{—}}_{ST}, Pₕₑₐₜ_{_{—}}_{mod}_{_{—}}_{LT}) both equal to zero. If the user is not requesting cooling at operation 114 (e.g., COOL_{req} is equal to zero), then the vehicle controller returns to operation 110, and sets all auxiliary load modifiers equal to zero. If the determination at operation 112 is negative, then the vehicle controller proceeds to operation 118.

The HVAC load value (HVAC_{load}) is compared to predetermined data at operation 118 to determine if the HVAC_{load} input indicates a cold temperature condition. If the determination at operation 118 is positive, then the vehicle controller proceeds to operation 120. The heating request (HEAT_{req}) is evaluated at operation 120. If the user is requesting heating (e.g., HEAT_{req} is greater than zero), then the vehicle controller proceeds to operation 122 and sets each heating modification value (Pₕₑₐₜ_{_{—}}_{mod}_{_{—}}_{ST}, Pₕₑₐₜ_{_{—}}_{mod}_{_{—}}_{LT}) equal to a predetermined value, and both cooling modification values (P_{cool}_{_{—}}_{mod}_{_{—}}_{ST}, P_{cool}_{_{—}}_{mod}_{_{—}}_{LT}) equal to zero. If the user is not requesting heating at operation 120 (e.g., HEAT_{req} is equal to zero), then the vehicle controller proceeds to operation 124 and sets all auxiliary load modifiers equal to zero. If the determination at operation 118 is negative, then the HVAC_{load} input indicates a nominal temperature condition, and the vehicle controller proceeds to operation 126.

The heating request (HEAT_{req}) input is evaluated at operation 126. If the user is requesting heating (e.g., HEAT_{req} is greater than zero), then the vehicle controller proceeds to operation 128 and evaluates the cooling request (COOL_{req}). If the determination at operation 128 is positive (e.g., COOL_{req} is greater than zero), then the vehicle controller proceeds to operation 130 and sets each of the short term auxiliary load modifiers (P_{cool}_{_{—}}_{mod}_{_{—}}_{ST}, Pₕₑₐₜ_{_{—}}_{mod}_{_{—}}_{ST}) and the long term auxiliary load modifiers (P_{cool}_{_{—}}_{mod}_{_{—}}_{LT}, Pₕₑₐₜ_{_{—}}_{mod}_{_{—}}_{LT}) equal to a predetermined value. If the determination at operation 128 is negative (e.g., COOL_{req} equals zero), then the vehicle controller proceeds to operation 132 and sets each heating modification value (Pₕₑₐₜ_{_{—}}_{mod}_{_{—}}_{ST}, Pₕₑₐₜ_{_{—}}_{mod}_{_{—}}_{LT}) equal to a predetermined value, and both cooling modification values (-P_{cool}_{_{—}}_{mod}_{_{—}}_{ST}, P_{cool}_{_{—}}_{mod}_{_{—}}_{LT}) equal to zero. If the determination at operation 126 is negative, then the vehicle controller proceeds to operation 134.

The cooling request (COOL_{req}) input is evaluated at operation 134. If the user is requesting cooling (e.g., COOL_{req} is greater than zero), then the vehicle controller proceeds to operation 136 and sets each cooling modification value (P_{cool}_{_{—}}_{mod}_{_{—}}_{ST}, P_{cool}_{_{—}}_{mod}_{_{—}}_{LT}) equal to a predetermined value, and both heating modification values (Pₕₑₐₜ_{_{—}}_{mod}_{_{—}}_{ST}, Pₕₑₐₜ_{_{—}}_{mod}_{_{—}}_{LT}) equal to zero. If the determination at operation 134 is negative (e.g., COOL_{req} equals zero), then the vehicle controller proceeds to operation 138 and sets each of the short term auxiliary load modifiers (P_{cool}_{_{—}}_{mod}_{_{—}}_{ST}, Pₕₑₐₜ_{_{—}}_{mod}_{_{—}}_{ST}) and the long term auxiliary load modifiers (P_{cool}_{_{—}}_{mod}_{_{—}}_{LT}, Pₕₑₐₜ_{_{—}}_{mod}_{_{—}}_{LT}) equal to zero.

With reference to FIG. 4, after determining the short term auxiliary load modifiers (P_{cool}_{_{—}}_{mod}_{_{—}}_{ST}, Pₕₑₐₜ_{_{—}}_{mod}_{_{—}}_{ST}) in operation 104, the vehicle controller proceeds to operation 140. The ID input is evaluated at operation 140. The ID input represents the identity of a user of the key. If the ID is recognized, then the vehicle controller proceeds to operation 142 and calculates the short term average accessory power values (P_{cool}_{_{—}}_{avg}_{_{—}}_{ST}, Pₕₑₐₜ_{_{—}}_{avg}_{_{—}}_{ST}, P_{LV}_{_{—}}_{avg}_{_{—}}_{ST}) using historical accessory power usage data that is associated with the ID, and saved in the memory of the vehicle controller. For example, in one embodiment the ID is recognized and ST is equal to five minutes; and the short term average heating power value (Pₕₑₐₜ_{_{—}}_{avg}_{_{—}}_{ST}) is calculated at operation 142 by taking a rolling average of the Pₕₑₐₜ_{_{—}}_{act}_{_{—}}_{ST} value and historical Pₕₑₐₜ_{_{—}}_{act}_{_{—}}_{ST} values that were received during the last recorded five minutes of data. If the ID is not recognized at operation 140, then the vehicle controller proceeds to operation 144 and calculates the short term average accessory power values (P_{cool}_{_{—}}_{avg}_{_{—}}_{ST}, Pₕₑₐₜ_{_{—}}_{avg}_{_{—}}_{ST}, P_{LV}_{_{—}}_{avg}_{_{—}}_{ST}) using default predetermined data.

After determining the long term auxiliary load modifiers (P_{cool}_{_{—}}_{mod}_{_{—}}_{LT}, Pₕₑₐₜ_{_{—}}_{mod}_{_{—}}_{LT}) in operation 106, the vehicle controller proceeds to operation 146. The ID input is evaluated at operation 146. If the ID is recognized, then the vehicle controller proceeds to operation 148 and calculates the long term average accessory power values (P_{cool}_{_{—}}_{avg}_{_{—}}_{LT}, Pₕₑₐₜ_{_{—}}_{avg}_{_{—}}_{LT}, P_{LV}_{_{—}}_{avg}_{_{—}}_{LT}) using historical accessory power usage data that is associated with the ID. If the ID is not recognized at operation 146, then the vehicle controller proceeds to operation 150 and calculates the long term average accessory power values (P_{cool}_{_{—}}_{avg}_{_{—}}_{LT}, Pₕₑₐₜ_{_{—}}_{avg}_{_{—}}_{LT}, P_{LV}_{_{—}}_{avg}_{_{—}}_{LT}) using default predetermined data.

After determining the short term average accessory power values (P_{cool}_{_{—}}_{avg}_{_{—}}_{ST}, Pₕₑₐₜ_{_{—}}_{avg}_{_{—}}_{ST}, P_{LV}_{_{—}}_{avg}_{_{—}}_{ST}) in operations 142 and 144, the vehicle controller proceeds to operation 152. Also, after determining the long term average accessory power values (P_{cool}_{_{—}}_{avg}_{_{—}}_{LT}, Pₕₑₐₜ_{_{—}}_{avg}_{_{—}}_{LT}, P_{LV}_{_{—}}_{avg}_{_{—}}_{LT}) in operations 148 and 150, the vehicle controller proceeds to operation 154.

The vehicle controller determines the short term auxiliary power value (Pₐᵤₓ_{_{—}}_{ST}) in operation 152, and the long term auxiliary power value (Pₐᵤₓ_{_{—}}_{LT}) in operation 154. FIG. 6 provides an enlarged view of the sub operations within the determinations of both the short term auxiliary power value in operation 152, and long term auxiliary power value in operation 154. The only difference between the determinations at operation 152 and 154 is the time period. Therefore the operations depicted in FIG. 6, are illustrated without reference to the time period, and apply to both the short term auxiliary power value (Pₐᵤₓ_{_{—}}_{ST}), and the long term auxiliary power value (Pₐᵤₓ_{_{—}}_{LT}).

In operation 156, the short term average low voltage power value (P_{LV}_{_{—}}_{avg}_{_{—}}_{ST}) is calculated by first calculating an actual low voltage power value as a product of the I_{LV}_{_{—}}_{act}, and V_{LV}_{_{—}}_{act} inputs, and then taking a rolling average of this actual low voltage power value over the predetermined short time period (ST). The long term average low voltage power (P_{LV}_{_{—}}_{avg}_{_{—}}_{LT}) is also calculated in operation 156 by taking a rolling average of the actual low voltage power value over the predetermined long time period (LT). After calculating the average low voltage power values, the vehicle controller proceeds to operation 158.

In operation 158, the short term cooling modification value (-P_{cool}_{_{—}}_{mod}_{_{—}}_{ST}) is compared to the short term average cooling value (P_{cool}_{_{—}}_{avg}_{_{—}}_{ST}) to determine if (P_{cool}_{_{—}}_{mod}_{_{—}}_{ST} is greater than P_{cool}_{_{—}}_{avg}_{_{—}}_{ST}). If the determination at operation 158 is positive, then the vehicle controller proceeds to operation 160. In operation 160 the short term heating modification value (Pₕₑₐₜ_{_{—}}_{mod}_{_{—}}_{ST}) is compared to the short term average heating value (Pₕₑₐₜ_{_{—}}_{avg}_{_{—}}_{ST}) to determine if (Pₕₑₐₜ_{_{—}}_{mod}_{_{—}}_{ST} is greater than Pₕₑₐₜ_{_{—}}_{avg}_{_{—}}_{ST}). If the determination at operation 160 is positive then vehicle controller proceeds to operation 162 and calculates the short term auxiliary power value (Pₐᵤₓ_{_{—}}_{ST}) based on the sum of the short term average low voltage power value (P_{LV}_{_{—}}_{avg}_{_{—}}_{ST}), the short term cooling modification value (P_{cool}_{_{—}}_{mod}_{_{—}}_{ST}) and the short term heating modification value (Pₕₑₐₜ_{_{—}}_{mod}_{_{—}}_{ST}). If the determination at operation 160 is negative, then the vehicle controller proceeds to operation 164 and calculates the short term auxiliary power value (Pₐᵤₓ_{_{—}}_{ST}) based on the sum of the short term average low voltage power value (P_{LV}_{_{—}}_{avg}_{_{—}}_{ST}), the short term cooling modification value (P_{cool}_{_{—}}_{mod}_{_{—}}_{ST}) and the short term average heating value (Pₕₑₐₜ_{_{—}}_{avg}_{_{—}}_{ST}).

Additionally, in operation 158 the long term cooling modification value (P_{cool}_{_{—}}_{mod}_{_{—}}_{LT}) is compared to the long term average cooling value (P_{cool}_{_{—}}_{avg}_{_{—}}_{LT}) (P to determine if (P_{cool}_{_{—}}_{mod}_{_{—}}_{LT} is greater than P_{cool}_{_{—}}_{avg}_{_{—}}_{LT}). If the determination at operation 158 is positive, then the vehicle controller proceeds to operation 160. In operation 160 the long term heating modification value (Pₕₑₐₜ_{_{—}}_{mod}_{_{—}}_{LT}) is compared to the long term average heating value (Pₕₑₐₜ_{_{—}}_{avg}_{_{—}}_{LT}) to determine if (Pₕₑₐₜ_{_{—}}_{mod}_{_{—}}_{LT} is greater than Pₕₑₐₜ_{_{—}}_{avg}_{_{—}}_{LT}). If the determination at operation 160 is positive then vehicle controller proceeds to operation 162 and calculates the long term auxiliary power value (Pₐᵤₓ_{_{—}}_{LT}) based on the sum of the long term average low voltage power value (P_{LV}_{_{—}}_{avg}_{_{—}}_{LT}), the long term cooling modification value (P_{cool}_{_{—}}_{mod}_{_{—}}_{LT}) and the long term heating modification value (Pₕₑₐₜ_{_{—}}_{mod}_{_{—}}_{LT}). If the determination at operation 160 is negative, then the vehicle controller proceeds to operation 164 and calculates the long term auxiliary power value (Pₐᵤₓ_{_{—}}_{LT}) based on the sum of the long term average low voltage power value (P_{LV}_{_{—}}_{avg}_{_{—}}_{LT}), the long term cooling modification value (P_{cool}_{_{—}}_{mod}_{_{—}}_{LT}) and the long term average heating value (Pₕₑₐₜ_{_{—}}_{avg}_{_{—}}_{LT}).

If the determination at operation 158 is negative, then the vehicle controller proceeds to operation 166. In operation 166 the short term heating modification value (Pₕₑₐₜ_{_{—}}_{mod}_{_{—}}_{ST}) is compared to the short term average heating value (Pₕₑₐₜ_{_{—}}_{avg}_{_{—}}_{ST}) to determine if (Pₕₑₐₜ_{_{—}}_{avg}_{_{—}}_{ST} is greater than Pₕₑₐₜ_{_{—}}_{avg}_{_{—}}_{ST}). If the determination at operation 166 is positive then vehicle controller proceeds to operation 168 and calculates the short term auxiliary power value (Pₐᵤₓ_{_{—}}_{ST}) based on the sum of the short term average low voltage power value (P_{LV}_{_{—}}_{avg}_{_{—}}_{ST}), the short term average cooling value (P_{cool}_{_{—}}_{avg}_{_{—}}_{ST}) and the short term heating modification value (Pₕₑₐₜ_{_{—}}_{mod}_{_{—}}_{ST}). If the determination at operation 166 is negative, then the vehicle controller proceeds to operation 170 and calculates the short term auxiliary power value (Pₐᵤₓ_{_{—}}_{ST}) based on the sum of the short term average low voltage power value (P_{LV}_{_{—}}_{avg}_{_{—}}_{ST}), the short term average cooling value (P_{cool}_{_{—}}_{avg}_{_{—}}_{ST}) and the short term average heating value (Pₕₑₐₜ_{_{—}}_{avg}_{_{—}}_{ST}).

Additionally, in operation 166 the long term heating modification value (Pₕₑₐₜ_{_{—}}_{mod}_{_{—}}_{LT}) is compared to the long term average heating value (Pₕₑₐₜ_{_{—}}_{avg}_{_{—}}_{LT}) to determine if (Pₕₑₐₜ_{_{—}}_{mod}_{_{—}}_{LT} is greater than Pₕₑₐₜ_{_{—}}_{avg}_{_{—}}_{LT}). If the determination at operation 166 is positive then vehicle controller proceeds to operation 168 and calculates the long term auxiliary power value (Pₐᵤₓ_{_{—}}_{LT}) based on the sum of the long term average low voltage power value (P_{LV}_{_{—}}_{avg}_{_{—}}_{LT}), the long term average cooling value (P_{cool}_{_{—}}_{avg}_{_{—}}_{LT}) and the long term heating modification value (Pₕₑₐₜ_{_{—}}_{mod}_{_{—}}_{LT}). If the determination at operation 166 is negative, then the vehicle controller proceeds to operation 170 and calculates the long term auxiliary power value (Pₐᵤₓ_{_{—}}_{ST}) based on the sum of the long term average low voltage power value (P_{LV}_{_{—}}_{avg}_{_{—}}_{LT}), the long term average cooling value (P_{cool}_{_{—}}_{avg}_{_{—}}_{LT}) and the long term average heating value (Pₕₑₐₜ_{_{—}}_{avg}_{_{—}}_{LT}).

With reference to FIG. 4, after determining the short term auxiliary power value (Pₐᵤₓ_{_{—}}_{ST}) in operation 152, the vehicle controller proceeds to operation 172. The vehicle controller calculates the short term estimated travel range (DTE_{ST}) in operation 172 according to equation 1, which is reproduced below:

$$D T {E}_{ST} = \frac{{E}_{bat \_ avail} * {SP}_{veh \_ avg \_ ST}}{{P}_{drv \_ avg \_ ST} + {P}_{aux \_ ST}} \qquad Eq . 1$$

After determining the long term auxiliary power value (Pₐᵤₓ_{_{—}}_{LT}) in operation 154, the vehicle controller proceeds to operation 174. The vehicle controller calculates the long term estimated travel range (DTE_{LT}) in operation 174 according to equation 2, which is reproduced below:

$$D T {E}_{LT} = \frac{{E}_{bat \_ avail} * {SP}_{veh \_ avg \_ LT}}{{P}_{drv \_ avg \_ LT} + {P}_{aux \_ LT}} \qquad Eq . 2$$

The vehicle controller proceeds to operation 176 after calculating the short term estimated travel range (DTE_{ST}) in operation 172 and the long term estimated travel range (DTE_{LT}) in operation 174. The vehicle controller evaluates the customer state of charge (CSoC) input at operation 176. The CSoC input is compared to predetermined data to determine a short term weighting factor (ST %) and a long term weighting factor (LT %). The estimated travel range (DTE) is then calculated by blending the short term estimated travel range (DTE_{ST}) and the long term estimated travel range (DTE_{LT}) based on their corresponding weighting factor. After operation 176, the vehicle controller proceeds to operation 178.

The vehicle controller provides the estimated travel range (DTE) to the user interface at operation 178. The user interface displays a range indicator based on the estimated travel range (DTE).

With reference to FIG. 7, the user interface 16 is located within an instrument cluster 180 according to one or more embodiments. In other embodiments, the user interface may be located in a central portion of a dashboard 182 (“centerstack”). The user interface 16 may be a liquid crystal display (LCD), a plasma display, an organic light emitting display (OLED), or any other suitable display. The user interface 16 may include a touch screen or one or more buttons (not shown), including hard keys or soft keys, located adjacent the user interface 16 for effectuating driver input. Other operator inputs known to one of ordinary skill in the art may also be employed without departing from the scope of the present application. The user interface 16 may be a digital display, or an indicia (not shown) that is illuminated by an underlying light source in response to signals from the vehicle controller 14.

With reference to FIG. 8, the user interface 16 conveys information, such as the estimated travel range to the driver. The user interface 16 displays the estimated travel range as a numerical value, according to one or more embodiments. For example, as depicted in the illustrated embodiment, the user interface depicts an estimated travel range of “62” miles.

The user interface 16 also displays the estimated travel range as an image 184 according to one or more embodiments. In one embodiment, the image 184 includes a base element 186 and a target element 188. The base element 186 represents a current location of the vehicle. The target element 188 is positioned relative to the base element 186 according to the estimated travel range, and represents the location at which vehicle will have depleted all of its available electrical energy. The image 184 may also include a charge element 190 representing a location of a charging station (not shown) relative to the vehicle.

In another embodiment, the image 184 includes a battery indicia 192 depicted as containing fluid. The battery indicia 192 includes a fill level 194 that corresponds to the amount of available electric energy.

While the best mode has been described in detail, those familiar with the art will recognize various alternative designs and embodiments within the scope of the following claims. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications.

What is claimed is:

1. A vehicle system comprising:
a controller configured to receive input indicative of available electric energy of a storage device, actual electrical power usage of a climate control system, and thermal requests, and to generate output indicative of an estimated travel range in response to the input; and
an interface communicating with the controller and configured to display a range indicator based on the estimated travel range.

2. The vehicle system of claim 1 wherein the input is dependent solely upon data generated by internal vehicle systems.

3. The vehicle system of claim 1 wherein the controller is further configured to:
generate an auxiliary power value based on the actual electrical power usage and the thermal requests; and
generate the output indicative of the estimated travel range based on the auxiliary power value and the available electric energy.

4. The vehicle system of claim 3 wherein the controller is further configured to:
receive an identity signal indicative of a driver;
calculate an average accessory power value based on the actual electrical power usage and historic electrical power usage associated with the driver;
generate a power modification value that is indicative of future electrical power usage based on the thermal requests and input indicative of a vehicle temperature; and
generate the auxiliary power value based on the average accessory power value and the power modification value.

5. The vehicle system of claim 1 wherein the thermal requests include a heat request indicative of future electrical power provided to a climate control system for increasing a vehicle temperature.

6. The vehicle system of claim 1 wherein the thermal requests include a cool request indicative of future electrical power provided to a climate control system for decreasing a vehicle temperature.

7. The vehicle system of claim 1 wherein the input for the actual electrical power includes electrical power provided to a motor for vehicle propulsion.

8. A vehicle comprising:
a controller configured to receive input indicative of available electric energy of a battery, actual power provided to a motor and a climate control system, and thermal requests, and to provide output indicative of an estimated travel range in response to the input.

9. The vehicle of claim 8 further comprising:
the motor;
the climate control system;
the battery, wherein the battery is connected to the motor and the climate control system; and
an interface communicating with the controller and configured to display an image having a base element representing a vehicle and a target element positioned relative to the base element according to the estimated travel range.

10. The vehicle of claim 9 further comprising a low voltage battery interconnected to the battery by a DC-DC converter and wherein the controller is further configured to receive input indicative of actual electrical power provided to the low voltage battery.

11. A method of controlling an electric vehicle comprising:
receiving input indicative of an identity of a driver, available electric energy of a storage device, and actual electrical power usage of at least one of a climate control system and a motor for vehicle propulsion; and
displaying an estimated travel range based on the input and historic electrical power usage associated with the driver.

12. The method of claim 11 further comprising:
generating at least one auxiliary power value based on the actual electrical power usage of the climate control system and thermal requests that are indicative of future electrical power usage; and
generating the estimated travel range based on the at least one auxiliary power value.

13. The method of claim 12 wherein generating at least one auxiliary power value comprises:
calculating an average accessory power value based on the actual electrical power usage of the climate control system and a predetermined time period;
generating an auxiliary load modification value based on the thermal requests; and
generating the at least one auxiliary power value based on the average accessory power value and the auxiliary load modification value.

14. The method of claim 13 wherein the auxiliary power value is equal to the greater of the average accessory power value and the auxiliary load modification value.

15. The method of claim 13 wherein generating the auxiliary load modification value further comprises:
receiving a HVAC load value indicative of a vehicle temperature; and
generating a heating modification value and a cooling modification value based on the HVAC load value.

16. The method of claim 12 further comprising:
calculating an average accessory power value based on the actual electrical power usage of the climate control system and the historic electrical power usage associated with the driver;
generating an auxiliary load modification value based on the thermal requests; and
generating the at least one auxiliary power value based on the average accessory power value and the auxiliary load modification value.

17. The method of claim 16 further comprising calculating the average accessory power value based on the actual electrical power usage of the climate control system and default electrical power data when the identity of the driver is not recognized.

18. The method of claim 11 further comprising:
generating a short term auxiliary power value and a long term auxiliary power value based on the actual electrical power usage of the climate control system and thermal requests that are indicative of future electrical power usage;
generating a short term estimated travel range based on a predetermined short time period, the short term auxiliary power value, the actual electrical power usage of the motor, and the available electric energy;
generating a long term estimated travel range based on a predetermined long time period, the long term auxiliary power value, the actual electrical power usage of the motor, and the available electric energy; and
generating the estimated travel range based on the short term estimated travel range and the long term estimated travel range.

19. The method of claim 18 wherein generating the estimated travel range further comprises:
receiving input indicative of a battery state of charge;
generating a short term weighting factor and a long term weighting factor based on the battery state of charge; and
calculating the estimated travel range based on a product of the short term estimated travel range and the short term weighting factor, and a product of the long term estimated travel range and the long term weighting factor.

20. The method of claim 18 wherein generating a short term estimated travel range further comprises:
calculating a short term average vehicle speed based on input indicative of a motor speed and the predetermined short time period;
calculating a short term average driving power based on the actual electrical power usage of the motor and the predetermined short time period; and
calculating the short term estimated travel range based on the short term average vehicle speed, the available electric energy and a sum of the short term average driving power and the short term auxiliary power value.
